(19) United States
(12) Patent Application Publication
(10) Pub. No.: US 2026/0047550 A1
(43) Pub. Date: Feb. 19, 2026

(54) COLLAR LINKING DEVICE WITH GPS FUNCTIONALITY

(71) Applicant: Christine Moyes, Tallahassee, FL (US)

(72) Inventor: Christine Moyes, Tallahassee, FL (US)

(21) Appl. No.: 18/804,349

(22) Filed: Aug. 14, 2024

(51) Int. Cl. A01K 11/00; A01K 27/00; A44B 11/00; A44B 11/25

(52) U.S. Cl. CPC A01K 11/008; A01K 27/009; A44B 11/005; A44B 11/2549; A01K 27/001; A44B 11/2519

(57) ABSTRACT

A linking device that can be added between the existing buckles of an external harness—such as a strap or collar. The linking device includes a GPS receiver and a radio frequency transmitter. The GPS receiver determines the present location of the linking device and the transmitter transmits the location information to a remote device such as a smartphone, tablet, laptop, or dedicated base station. The present location of the linking device can be determined and displayed on the remote device. The linking device also monitors the state of its connections to the external harness and can take action in response to a change of state.

### CROSS-REFERENCES TO RELATED APPLICATIONS

Not Applicable.

### STATEMENT REGARDING FEDERALLY SPONSORED RESEARCH OR DEVELOPMENT

Not Applicable.

### MICROFICHE APPENDIX

Not Applicable.

### BACKGROUND OF THE INVENTION

### 1. Field of the Invention

This invention relates to the field of tracking and communication devices. More specifically, the invention comprises a linking device that can be added between the buckles of an existing strap or collar in order to provide GPS tracking, communication, and other functions.

### 2. Description of the Related Art

The present invention is suitable for use with a wide variety of products that employ elastically deforming buckles to attach a strap, collar, or similar device. The exemplary embodiments described in this disclosure focus on a dog collar. However, the invention is by no means limited to this application and many additional and diverse applications will occur to those skilled in the art.

FIG. 1 shows a prior art collar 10, such as used for a dog. Strap 12 provides the necessary tensile strength. Adjustment buckle 24 is used to adjust the circumference of the collar by increasing or decreasing the length of the doubled portion. D ring 22 is used to attach identifying tags and often an external leash. Most such collars now incorporate a quick-release buckle mechanism. The term “quick release buckle mechanism” means any buckle where two parts are disconnected by a simple user action—such as squeezing, turning, or twisting.

The example shown uses a “side buckle” quick release buckle mechanism. The term “side buckle” refers to the fact that the user squeezes inward on the two sides of an engaged buckle assembly to release the connection. The buckle assembly includes a male side buckle 14 on one end of the collar and a female side buckle 16 on the other end. Strap ring 18 is incorporated into male side buckle 14. Strap 12 is passed through the strap ring and sewn or otherwise secured back to itself to form a tension-carrying connection. Female side buckle 16 likewise includes a strap ring 20 that is used for securing the strap 12.

Male side buckle 14 includes a central prong 26 that is flanked by a first elastic prong 28 and a second elastic prong 30. In order to engage the male side buckle 14 to the female side buckle 16, the three prongs 26,28,30 are passed into the hollow interior of prong receiver 32. The two elastic prongs 28,30 elastically deflect inward until the enlarged leading portions of these prongs pop laterally outward into first side relief 34 and second side relief 36 of female side buckle 16. A mechanical interference results that holds the side buckle assembly together. In order to release the side buckle assembly, the user presses inward on the exposed portions of the prongs 28,30 and pulls the male and female portions apart.

Buckle assemblies such as shown in FIG. 1 are very common. The present invention takes advantage of this fact to add a convenient electronics module to prior art collars, backpack straps, helmet straps, and other comparable devices.

### BRIEF SUMMARY OF THE INVENTION

The present invention comprises a linking device that can be added between the existing buckles of a strap or collar. The linking device includes a GPS receiver and a radio frequency transmitter. The GPS receiver determines the present location of the linking device and the transmitter transmits the location information to a remote device such as a smartphone, tablet, laptop, or dedicated base station. The present location of the linking device can be determined and displayed on the remote device. The linking device also monitors the state of its connections to the external harness and can take action in response to a change of state.

The physical connections allow the linking device to be connected as part of an external harness—such as a backpack harness, a dog collar, or other similar items. The physical connections also allow the linking device to be easily removed from one harness or collar and attached to another. Thus, a single instance of the inventive device can be used in many different applications.

### BRIEF DESCRIPTION OF THE SEVERAL VIEWS OF THE DRAWINGS

FIG. 1 is a perspective view, showing a prior art side buckle assembly installed on a dog collar.

FIG. 2 is a perspective view, showing an embodiment of the present invention.

FIG. 3 is a perspective view, showing the embodiment of FIG. 3 with an access cover removed.

FIG. 4 is a perspective view, showing the embodiment of FIG. 2 installed on a dog collar.

FIG. 5 is a section plan view, showing the operation of a first switch.

FIG. 6 is a perspective view, showing optional buttons and indicators.

FIG. 7 is a schematic view, showing exemplary electronics.

FIG. 8 is a graphical view, showing communication between the inventive linking device and an external monitoring device.

FIG. 9 is a perspective view, showing an alternate embodiment incorporating an air tag receiver.

### REFERENCE NUMERALS IN THE DRAWINGS

10 collar
12 strap
14 male side buckle
16 female side buckle
18 strap ring
20 strap ring
22 D ring
24 adjustment buckle
26 central prong
28 first elastic prong
30 second elastic prong
32 prong receiver
34 first side relief
36 second side relief
38 linking device
40 housing
42 undercut
44 retention edge
46 cover
48 GPS antenna
50 PC board
52 battery
54 processor
56 first switch
57 plunger
58 second switch
60 R/F transceiver
6
62 GPS receiver
64 button
66 indicator
68 indicator
70 charge input
71 speaker
72 LED driver
74 charge controller
76 power distribution
78 memory
80 cellular network
82 cellular phone
84 display
86 location icon
88 selection icon
90 linking device
92 cover
94 expanded housing
96 air tag
98 air tag receiver

### DETAILED DESCRIPTION OF THE INVENTION

An objective of the present invention is to add a GPS tracking device to a wide variety of prior art harnesses incorporating quick release buckle mechanisms. In the present disclosure, the term “harness” broadly encompasses any device featuring a buckle mechanism. Examples include dog collars, backpack straps, climbing harnesses, and helmet chin straps. The term includes connections between multiple objects in addition to straps where both ends of the strap connect to a single object.

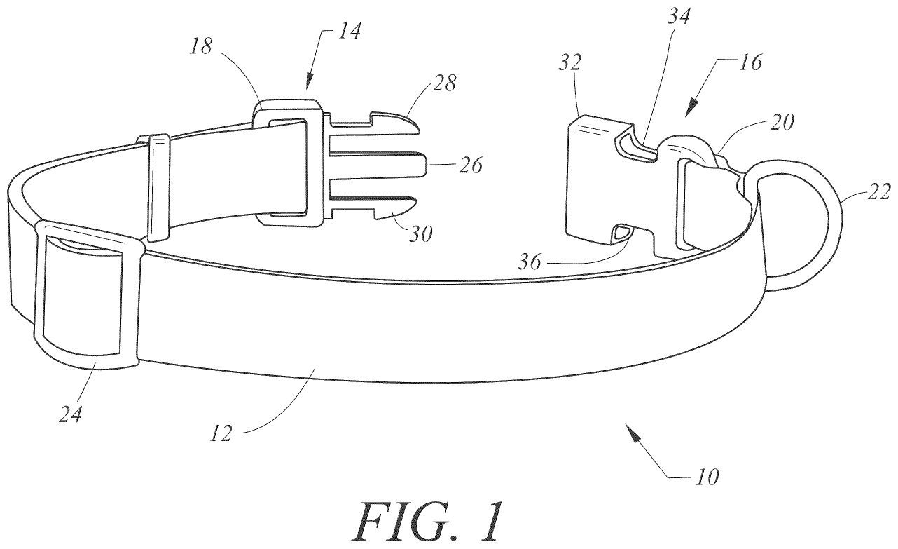

It is impractical to illustrate all these different applications. Accordingly, a dog collar such as shown in FIG. 1 will serve as an exemplary “harness.” Those skilled in the art will readily appreciate how the invention applies to many other types of harnesses. Thus, the invention is by no means limited to one particular type of harness.

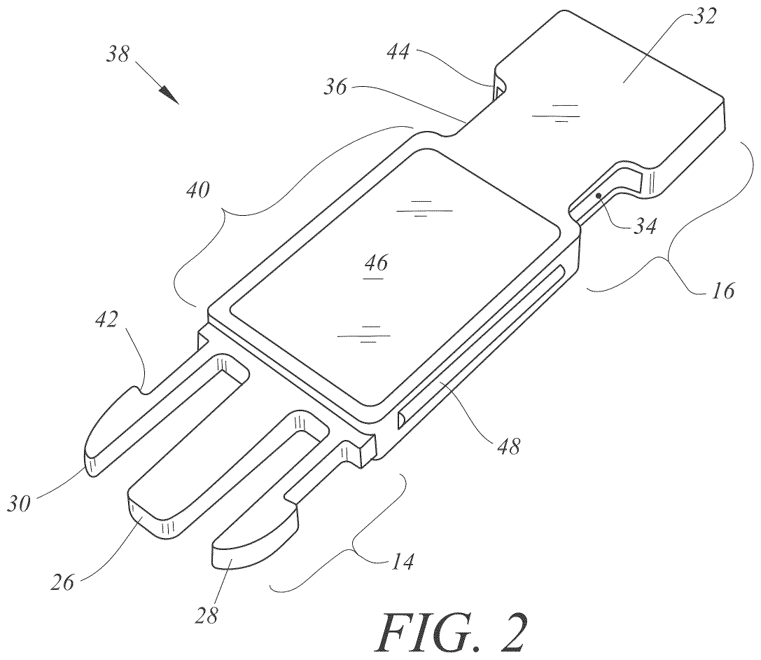

FIG. 2 illustrates an exemplary embodiment of the invention—designated as linking device 38. The term “linking device” refers to (1) the fact that the physical structure of the invention links into an existing harness buckle arrangement, and (2) the fact that the electronics contained within the invention allow it to link wirelessly to other devices. The invention can be configured for use with any of the various quick release buckle mechanisms. The example of FIG. 2 is intended for use with a side buckle mechanism.

Housing 40 includes a hollow interior that is sealed by cover 46. Male side buckle 14 is provided on a first end of the housing and female side buckle 16 is provided on a second end. The male side buckle includes the components needed to selectively connect to a female side buckle on an external harness—central prong 26, first elastic prong 28, and second elastic prong 30.

The female side buckle likewise includes the components needed to selectively connect to a male side buckle on an external harness. Prong receiver 32 receives the prongs of the external male connector. First side relief 34 and second side relief 36 allow the elastic prongs of the male side buckle on the external harness to pop laterally outward and create an interference that ensures the connection. GPS antenna 48 is provided in a convenient location—such as along the side of the housing (shown).

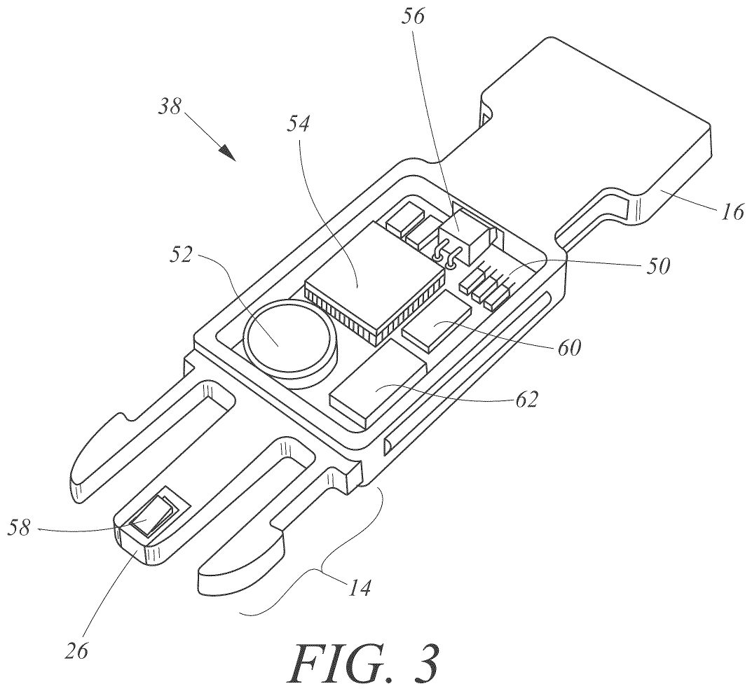

FIG. 3 shows the embodiment of FIG. 2 with cover 46 removed. In this example the electronics within the linking device are mounted on PC board 50. Battery 52—which in this instance includes a stack of individual cells in a holder that is attached to the PC board—provides electrical power. Processor 54 includes an associated memory on the same integrated chip. The processor retrieves software from its associated memory and executes this software to govern the functions of the inventive device. GPS receiver 62 processes satellite GPS signals and uses these to determine a present location of the device. R/F transceiver 60 allows radio frequency communications with external devices. These communications may assume the form of a short-range communication protocol, such as the BLUETOOTH protocol promulgated by the Bluetooth Special Interest Group of Kirkland, Washington, U.S.A. Long-range communications—such as via the use of a cellular network—are also provided in some embodiments.

In some embodiments, actions taken by the linking device depend on whether one or more of its quick release buckle mechanisms are connected to an external harness. Switches are provided to determine the state of these connections. First switch 56 is mounted on the PC board itself. A movable plunger extends from first switch 56 into the female side buckle 16. The plunger on first switch 56 is actuated when the central prong of a male connector on an external harness advances to the connected position within female side buckle 16.

Second switch 58 is provided on central prong 26 of male side buckle 14 on linking device 38. Second switch 58 is actuated when central prong 26 of male side buckle 14 advances to the connected position within a female connector on an external harness.

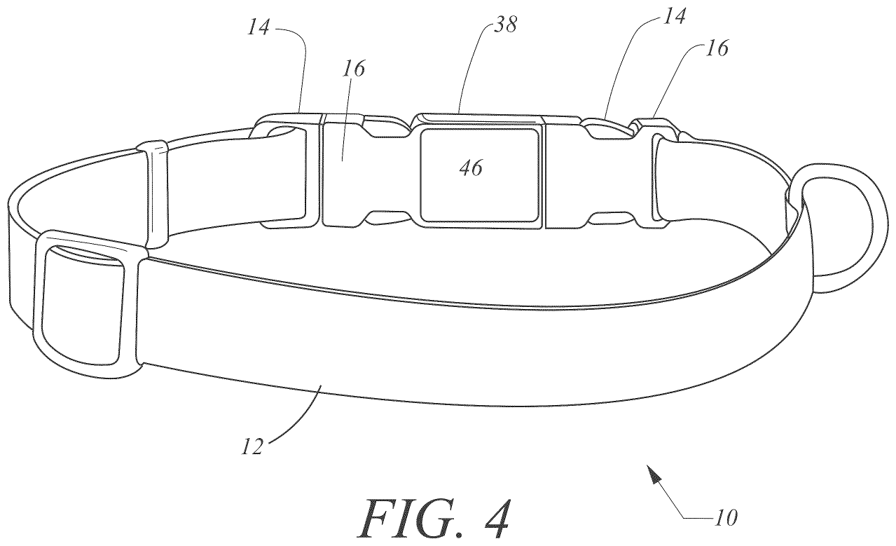

FIG. 4 depicts the inventive linking device 38 connected into a prior art harness—collar 10. Male side buckle 14 of linking device 38 is connected to female side buckle 16 of the external harness. Female side buckle 16 of linking device 38 is connected to male side buckle 14 of the external harness. In this example, the circular integrity of collar 10 is maintained despite the addition of the inventive linking device.

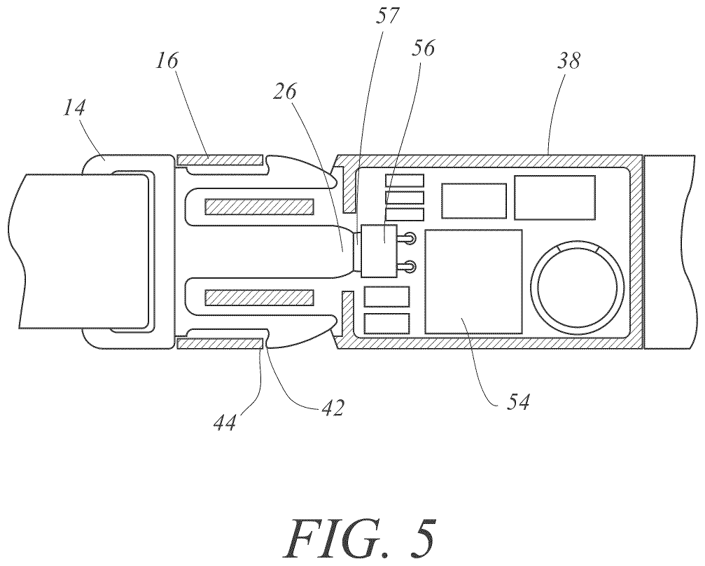

FIG. 5 provides a sectional view through the housing of the linking device, with the configuration shown in FIG. 4. Plunger 57 extends from first switch 56. When male side buckle 14 of the external harness is inserted into female side buckle 16 of the linking device 38, the tip of central prong 26 bears against plunger 57 and pushes it into the body of first switch 56. This action changes the state of the first switch (changing it from an open circuit to a closed circuit).

FIG. 5 also shows the operation of the prior art side buckle connecting mechanism. Each elastic prong includes an undercut 42. This undercut extends laterally over retention edge 44 on the side relief of the female side buckle 16. The engagement of undercut 42 and retention edge 44 means that the male and female components of the side buckle cannot be disconnected without pressing inward on the elastic prongs.

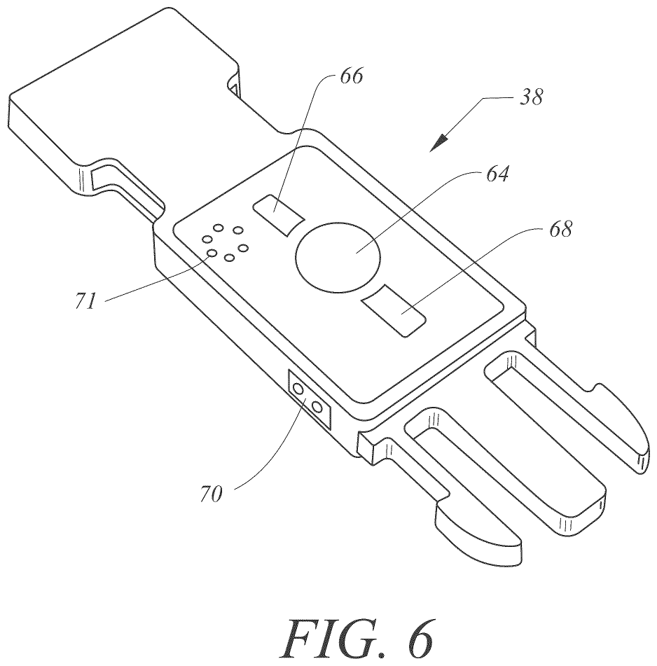

FIG. 6 shows the opposite side of linking device 38. The side facing the viewer in FIG. 6 is opposite to the side facing the viewer in FIG. 4. Interface and communication devices are preferably included on the outward facing side. In the version of FIG. 6, button 64 is provided. Indicators 66,68 are also provided. The button can be used to activate the device and to change settings. The indicators can provide information, illumination, or both. Charge input 70 is provided so that the inventive linking device can be connected to an external battery charger. An inductive charging system can also be used.

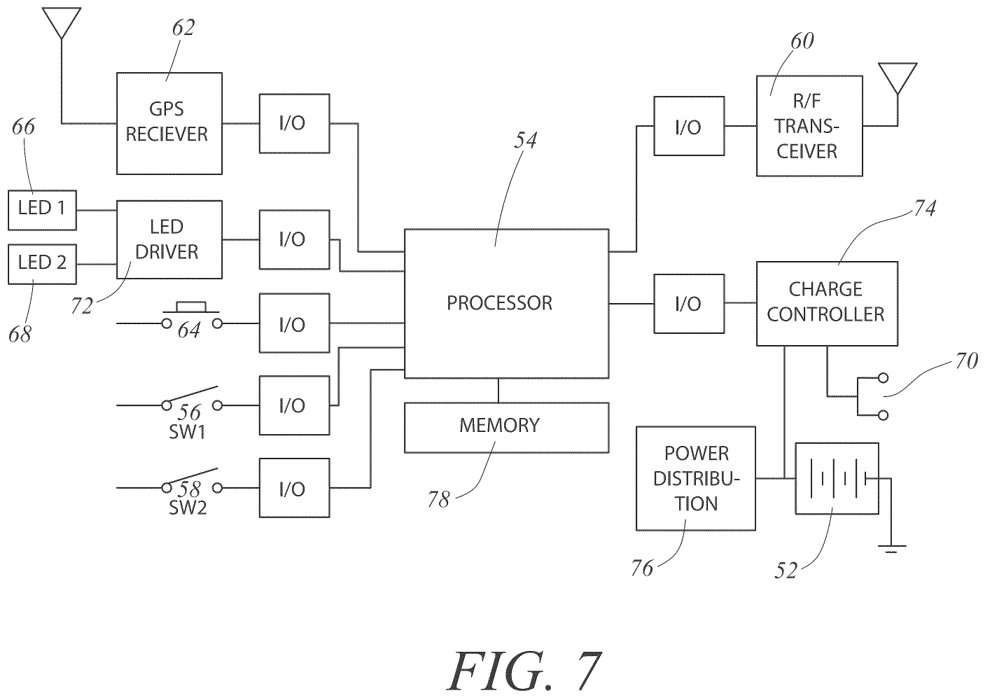

The electronics contained within the inventive linking device can assume an endless variety of forms. FIG. 7 shows an exemplary embodiment. Processor 54 pulls executable software from its associated memory 78. Operational states and parameter values are likewise stored in memory 78. The processor includes numerous input/output (“I/O”) ports that allow it to communicate with external devices. GPS receiver 62 receives satellite signals and internally processes these to provide a current position. This position information is then fed to the processor through an I/O port. LED driver 72 drives indicators 66 and 68. It receives instructions from the processor.

Push button 64, first switch 56, and second switch 58, also provide inputs to the processor. These inputs are simply a “closed” or “open” state for each of these devices. The processor receives these states and acts in response to them.

R/F transceiver 60 provides wireless communications with external devices—whether short range, long range, or both. Charge controller 74 regulates the charge state of battery 52. The battery provides electrical power to all the other components through a series of connections represented in block form as power distribution 76.

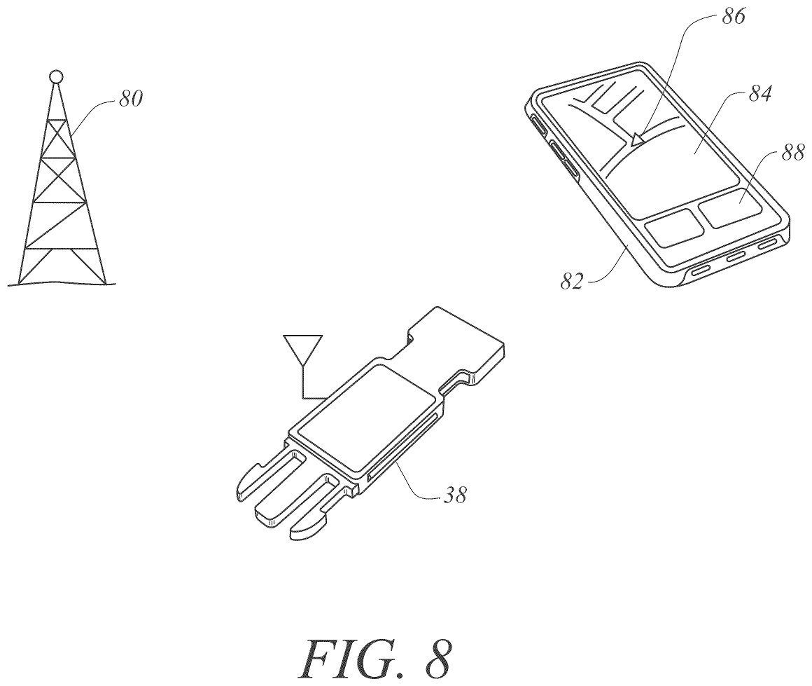

The invention can be configured to perform a variety of actions, depending on the software executed by the processor. As a first example, the inventive linking device can act as a GPS tracking device. As explained previously, the linking device can be added to any external harness. The electronics can then be activated—such as by pressing button 64. It is convenient to provide monitoring and control functions by way of an external linked device. FIG. 8 illustrates this scenario. Linking device 38 is wirelessly linked to cellular phone 82 using any suitable communication format—BLUETOOTH being a good example. The cell phone includes a graphical user interface (“GUI”) presented on display 84. Once linking device 38 is activated, it transmits GPS location data to cell phone 82. That data is then converted to a depiction such as location icon 86 on a moving map. Selection icons 88 are also provided in the GUI. These allow the person possessing the cell phone to monitor the status of linking device 38 and send commands to the linking device.

In some instances short range communications will be insufficient and longer range communications will be preferred. In these examples the transceiver within the linking device is provided with the capability to use cellular networks 80. The cellular networks can be used to provide one or two-way communication between the linking device and the cell phone.

The presence of the two switches that monitor for the connection of the quick release buckle mechanisms in the inventive linking device allows more functionality. As an example, the linking device can be configured to monitor for a connected state in the first switch and the second switch. A low-power query signal can be used to monitor for this without fully activating the processor and consuming too much battery power. When a connected state is detected for both switches, the inventive linking device can then power up the processor and initiate the full functionality of the device.

This approach is useful for a helmet strap—among other things. When the user connects the helmet chin strap, the linking device becomes active. A parent with a child riding a bicycle may wish to use this approach. The parent would get a notice on cell phone 82 that the chin strap has been connected and could then monitor the progress of the child as the linking device 38 transmits periodic position reports. In some embodiments the processor contains an accelerometer that can be used to monitor for excessive acceleration—possibly indicating a crash. If excessive acceleration is detected the linking device transmits a warning signal that is displayed on cell phone 82.

An action of the inventive linking device can also be triggered by the disconnection of one of the buckle mechanisms. An application for this scenario is a dog collar used for a wide-ranging dog like a deer hound. Processor 54 can be configured to transmit a location signal if a disconnection of either buckle mechanism is detected. In that scenario it is not normal for the collar to become disconnected far away from the owner. A “collar disconnected” signal can be sent to a remotely linked device, along with the position at the time of disconnection. This signal can be sent via a cellular network connection. The user then knows (1) where the dog was located at the time of disconnection, and (2) where to search for the collar, since it likely will remain at the location of disconnection.

Looking again at FIG. 8, some of the selection icons 88 can be used to initiate commands sent from the cell phone to linking device 38. These commands are then acted on by linking device 38. In the case where the linking device is used as a dog collar, for example, the user can send a “tone” command. Looking at FIG. 6, the tone command causes the processor to emit a tone through speaker 71. The dog hears this tone, which can be used for training purposes. A different command could be used to cause one or both indicators 66,68 to flash brightly. This can be used to assist in finding a dog at night.

Additional embodiments of the invention can include independent and even external communication devices. An example of such an external communication device is the AIRTAG tracking device marketed by Apple, Inc., of Cupertino, California, U.S.A. The AIRTAG device communicates using BLUETOOTH signals. These only allow communication over a short range. However, a communication between an AIRTAG device and a nearby BLUETOOTH-equipped device (such as a smartphone) can be transformed into a much longer range communication using crowdsourced networks. In this approach the BLUETOOTH device making contact with the AIRTAG transmits a location to other BLUETOOTH devices and the information makes it way to a particular external device that has been associated with the AIRTAG. The transfer of information using this approach can be quite rapid in areas having a high density of BLUETOOTH devices.

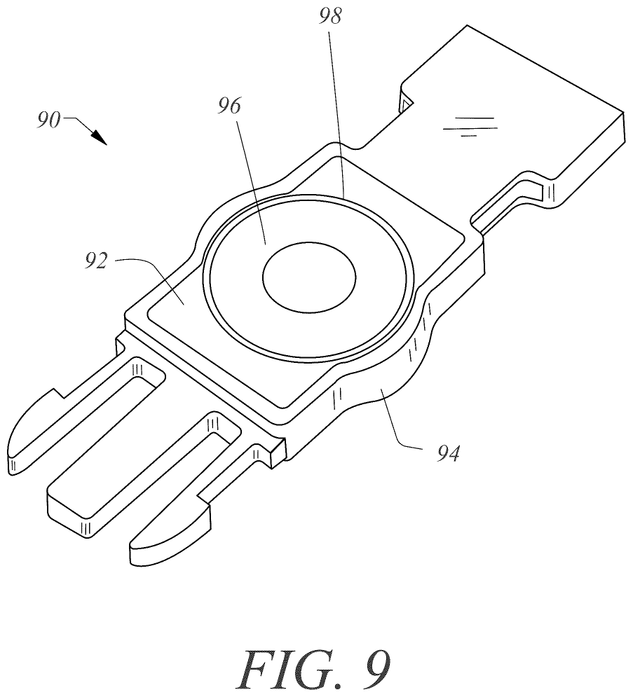

FIG. 9 shows an alternate embodiment of linking device 90 that is designed to receive an AIRTAG. Expanded housing 94 includes a bulging mid section. A corresponding expanded cover 92 includes AIRTAG receiver 98. An AIRTAG 96 is placed within AIRTAG receiver 98. Resilient capturing devices are provided to hold the AIRTAG in the receiver, unless a user pries it out. Thus, linking device 90 includes all the previously described internal components and an external AIRTAG as well.

Many other features can be added to the inventive embodiments, singly or in combination. These include:
1. Potting the electronics in the housing to provide a ruggedized containment;
2. A housing with overlapped male and female connections so that the overall length is not changed significantly when the inventive linking device is added;
3. An embodiment where one or more of the state sensing switches is an optocoupler, a Hall effect switch, or a reed switch;
4. An embodiment where the housing is curved so that is more smoothly blends into a curved shape like a dog collar.

Although the preceding descriptions contain considerable detail, the invention is by no means limited to the embodiments described. Many other embodiments will occur to those skilled in the art. Accordingly, the scope of the invention should be fixed by the following claims rather than the examples given.

Having described my invention, I claim:

1. A linking device configured to be selectively connected to an external harness having a male quick release buckle mechanism and a female quick release buckle mechanism, comprising:
(a) a housing;
(b) a male quick release buckle mechanism connected to a first side of said housing, said male quick release buckle mechanism being configured to selectively connect to said female quick release buckle mechanism of said external harness;
(c) a female quick release buckle mechanism connected to a second side of said housing, said female quick release buckle mechanism being configured to selectively connect to said male quick release buckle mechanism of said external harness;
(d) a processor within said housing, said processor running software loaded from an associated memory;
(e) a radio transmitter connected to said processor;
(f) a GPS receiver connected to said processor; and
(g) said processor being configured to use said radio transmitter to transmit position information received from said GPS receiver to an external linked device.

2. The linking device as recited in claim 1, further comprising:
(a) a first switch positioned to detect a first state of connection between said female quick release buckle mechanism on said housing and said male quick release buckle mechanism on said external harness; and
(b) said processor being configured to take an action in response to a change in said first state of connection.

3. The linking device as recited in claim 2, wherein said action is using said GPS receiver to determine a present position of said linking device.

4. The linking device as recited in claim 2, wherein said action is to establish a link to said external linked device.

5. The linking device as recited in claim 3, wherein said processor establishes a link to said external linked device and transmits said present position to said external linked device.

6. The linking device as recited in claim 1, further comprising:
(a) a first switch positioned to detect a first state of connection between said female quick release buckle mechanism on said housing and said male quick release buckle mechanism on said external harness;
(b) a second switch positioned to detect a second state of connection between said male quick release buckle mechanism on said housing and said female quick release buckle mechanism on said external harness; and
(c) said processor being configured to take an action in response to a change in said first state of connection or said second state of connection.

7. The linking device as recited in claim 6, wherein said action is activating said processor and said GPS receiver.

8. The linking device as recited in claim 6, wherein said action is using said GPS receiver to determine a present position of said linking device.

9. The linking device as recited in claim 1, further comprising an independent communication device receiver and an independent communication device.

10. The linking device as recited in claim 1, further comprising:
(a) a first switch positioned to detect a first state of connection between said female quick release buckle mechanism on said housing and said male quick release buckle mechanism on said external harness;
(b) a second switch positioned to detect a second state of connection between said male quick release buckle mechanism on said housing and said female quick release buckle mechanism on said external harness; and
(c) said processor being configured to take an action in response to a change in said first state of connection and said second state of connection.

11. A linking device configured to be selectively connected to an external harness having a male quick release buckle mechanism and a female quick release buckle mechanism, comprising:
(a) a housing;
(b) a male quick release buckle mechanism connected to a first side of said housing, said male quick release buckle mechanism being selectively connected to said female quick release buckle mechanism on said external harness;
(c) a female quick release buckle mechanism connected to a second side of said housing, said female quick release buckle mechanism being selectively connected to said male quick release buckle mechanism on said external harness;
(d) a processor within said housing, said processor running software loaded from an associated memory;
(e) a radio link communicating with said processor;
(f) a GPS receiver connected to said processor; and
(g) said processor being configured to use said radio transmitter to transmit position information received from said GPS receiver to an external linked device.

12. The linking device as recited in claim 11, further comprising:
(a) a first switch positioned to detect a first state of connection between said female quick release buckle mechanism on said housing and said male quick release buckle mechanism on said external harness; and
(b) said processor being configured to take an action in response to a change in said first state of connection.

13. The linking device as recited in claim 12, wherein said action is using said GPS receiver to determine a present position of said linking device.

14. The linking device as recited in claim 12, wherein said action is to establish a link to said external linked device.

15. The linking device as recited in claim 13, wherein said processor establishes a link to said external linked device and transmits said present position to said external linked device.

16. The linking device as recited in claim 11, further comprising:
(a) a first switch positioned to detect a first state of connection between said female quick release buckle mechanism on said housing and said male quick release buckle mechanism on said external harness;
(b) a second switch positioned to detect a second state of connection between said male quick release buckle mechanism on said housing and said female quick release buckle mechanism on said external harness; and
(c) said processor being configured to take an action in response to a change in said first state of connection or said second state of connection.

17. The linking device as recited in claim 16, wherein said action is activating said processor and said GPS receiver.

18. The linking device as recited in claim 16, wherein said action is using said GPS receiver to determine a present position of said linking device.

19. The linking device as recited in claim 18, further comprising an independent communication device receiver and an independent communication device.

20. The linking device as recited in claim 11, further comprising:
(a) a first switch positioned to detect a first state of connection between said female quick release buckle mechanism on said housing and said male quick release buckle mechanism on said external harness;
(b) a second switch positioned to detect a second state of connection between said male quick release buckle mechanism on said housing and said female quick release buckle mechanism on said external harness; and
(c) said processor being configured to take an action in response to a change in said first state of connection and said second state of connection.
